(19) United States
(12) Patent Application Publication
(10) Pub. No.: US 2005/0192820 A1
(43) Pub. Date: Sep. 1, 2005

(54) Method and apparatus for creating and distributing recordings of events

(76) Inventors: Steven G. Simon, Cambridge, MA (US); Alexander Mark Goodman, Newton, MA (US); Craig E. Pinkus, Carmel, IN (US)

Correspondence Address: BOSE MCKINNEY & EVANS LLP, 135 N PENNSYLVANIA ST, SUITE 2700, INDIANAPOLIS, IN, 46204, US

(21) Appl. No.: 10/788,867

(22) Filed: Feb. 27, 2004

(51) Int. Cl. G06F 17/60

(52) U.S. Cl. 705/1; 705/26

(57) ABSTRACT

A method for creating and distributing recordings of events may include the steps of negotiating with an artist and a promoter or venue, obtaining rights to create and distribute copies of a recording of the event before the event occurs, pre-selling copies of the recording of the event, creating copies of the recording of the event, distributing copies of the recording of the event, and distributing revenue generated by distribution of the copies.

### FIELD OF THE INVENTION

The present device generally relates to methods and apparatuses for creating and distributing recordings of live events, and more particularly to methods and apparatuses for enabling attendees of an event to obtain recordings of the event at the conclusion of the event.

### BACKGROUND AND SUMMARY

Some attendees of live events such as concerts may wish to obtain a recording of the event. Historically, attendees could obtain such recordings only if the performer(s) arranged for recording of the event and later offered to distribute copies of the recording to interested purchasers, if the performer(s) announced in advance of the event that attendees could bring equipment to the event to record the event, or if the attendees were willing to purchase illegally made recordings of the event (i.e., bootleg recordings). Each of these conventional alternatives is undesirable. Recordings produced by the performer(s) are typically not available for weeks or even months after the event is complete. Self-made recordings (with the performer's permission) are generally low quality as they are typically made with low quality equipment (such as hand-held recording devices) that records only ambient audio content, as opposed to the original audio signals provided to the performer's sound system. Bootleg recordings, in addition to being illegal, are also frequently of low quality for the same or similar reasons.

Accordingly, it is desirable to provide a method and apparatus for enabling attendees of an event to obtain lawful recordings of the event at the conclusion of the event. In addition to providing various different systems for creating substantially real time, high quality recordings of live events for distribution almost immediately after the conclusion of the event, the present invention provides various different methods for facilitating the lawful creation and distribution of such recordings. More particularly, the present invention provides methods whereby a service provider may negotiate the terms and conditions for creating and distributing such recordings, obtain the rights to legally create and distribute such recordings, prepare the appropriate materials that may be utilized during the creation and distribution of such recordings, execute the creation and distribution of such recordings on the day of the event, and distribute revenue and additional recordings after the day of the event.

These and other features of the present methods and apparatuses will become apparent and be further understood upon reading the detailed description provided below with reference to the following drawings.

### BRIEF DESCRIPTION OF THE DRAWINGS

FIG. 1 is a block diagram of one embodiment of an apparatus according to the present invention.

FIG. 2 is a flow chart of various steps that may be carried out during performance of a method according to the present invention.

FIG. 3A is a flow chart of steps that may be carried out as part of obtaining certain rights to lawfully practice a method according to the present invention.

FIG. 3B is a flow chart similar to the flow chart of FIG. 3A.

FIG. 4 is a flow chart of steps that may be carried out in preparing certain materials for use during the practice of a method according to the present invention.

FIG. 5 is a flow chart of steps that may be carried out to setup certain equipment and materials for use during the practice of a method according to the present invention.

FIG. 6 is a flow chart of various steps that may be carried out during the creation of recordings of an event using the apparatus of FIG. 1.

### DETAILED DESCRIPTION OF EXEMPLARY EMBODIMENTS

While the present invention is susceptible to various modifications and alternative forms, exemplary embodiments thereof have been shown by way of example in the drawings and will herein be described in detail. It should be understood, however, that there is no intent to limit the invention to the particular forms and methods disclosed, but on the contrary, the intention is to address all modifications, equivalents, and alternatives falling within the spirit and scope of this disclosure as defined by the appended claims.

The following description is presented in the context of the practice of methods according to the present invention by an individual or entity (hereinafter, a “service provider”) who interacts with individuals or entities who provide the content of a live event (hereinafter, the “artist”), individuals or entities who provide the particular location for the event such as a stadium, club, university, theatre, amphitheatre, convention center, church, festival, or other location (hereinafter, the “venue”), individuals or entities who engage both the artist and the venue and assume financial risk toward each (hereinafter, the “promoter”), and individuals who attend the event (hereinafter, “attendees”). It should be understood that while much of this description anticipates an event such as a concert performance of a musical work and accompanying words, much, but not all, of the following description of the teachings of the present invention is equally applicable to performances of dramatic works and accompanying words, poetry recitals, speeches, lectures, sermons, debates, and any other type of performance having an audio component.

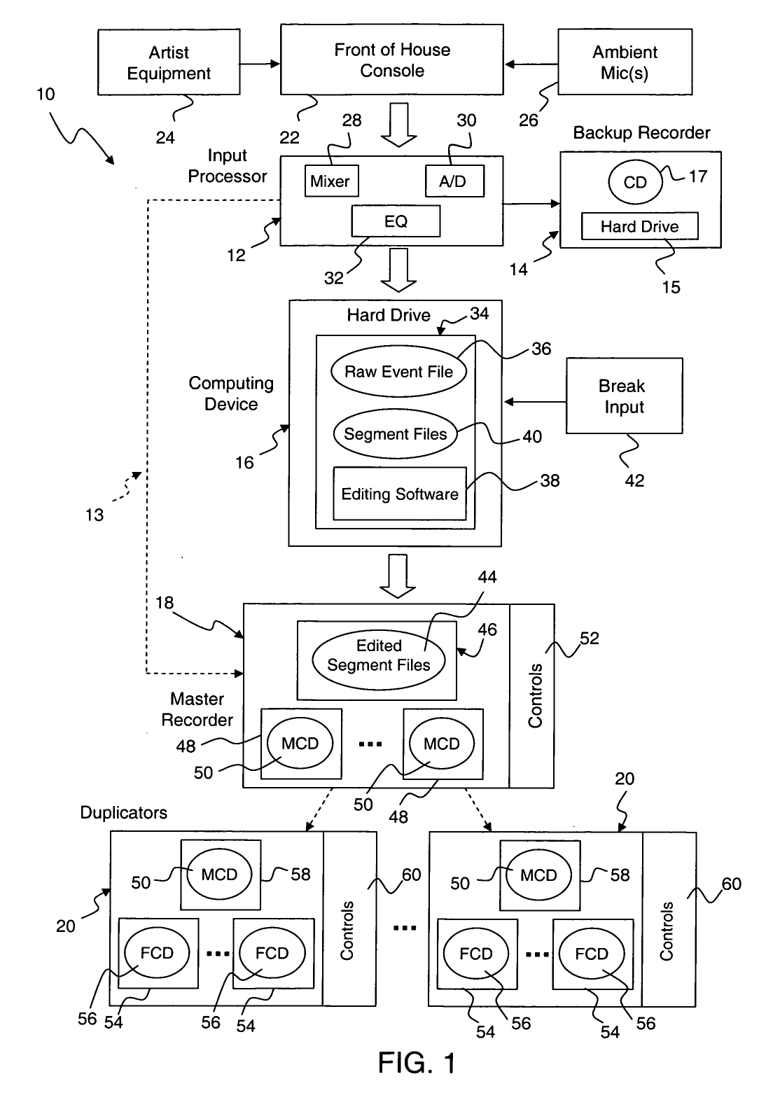

Referring now to FIG. 1, one configuration of a system suitable for creation of recordings of a live event during the practice of a method according to the present invention is shown. System 10 generally includes an input processor 12, a backup recorder 14, a computing device 16, a master recorder 18, and a plurality of duplicators 20. Input processor 12 is configured to receive an original audio signal from, for example, a front of house console 22 which may be provided and operated by agents of the artist as is customary in the music business. This signal may be provided as an analog signal (or plurality of analog signals) or as a digital signal (or plurality of digital signals) in the form of one or more channels via a cable (or cables) or one or more wireless connections to input processor 12. The original audio signal may include output signals from the artist's instruments and microphones and playback devices for pre-recorded material played during the event as represented by artist equipment block 24, and output signals from ambient microphones 26 situated in the venue to detect the audio reaction of the attendees during the event, all mixed and processed by the sound person or crew operating front of house console 22. As is well known in the art, if the original audio signal is provided via a cable, the quality of the signal will degrade as the length of the cable is increased, thereby limiting the maximum acceptable distance between the source of the original audio signal and input processor 12.

Input processor 12 may include a mixer 28 for combining channels of the original audio signal, an A/D converter 30 for converting original analog audio signals to digital audio signals, and/or an equalizer 32 for adjusting levels of certain components of the original audio signal. Of course, it should be understood that the various components of input processor 12 may be incorporated into a single unit or consist of a configuration of discrete units configured to perform specific functions. Moreover, in one embodiment described below, A/D converter 30 may be part of master recorder 18. It should also be understood that input processor 12 may be mounted in a mobile unit such as a truck or other vehicle, or located in a stationary position in an isolated area in the venue, or adjacent front of house console 22 as is further described below.

Computing device 16 may be a conventional personal computer, or other device having suitable features and capabilities for carrying out the functions described herein. Computing device 16 is configured to receive the output of input processor 12 via a wired or wireless connection. Computing device 16 may include, in addition to a display, input device(s), processor, etc. (none shown), a hard drive 34 for storing a digital version of the output of input processor 12 as a raw event file 36, and editing software 38 for editing raw event file 36 to create segment files 40, as further described below. Break input 42, which is used by computing device 16 to define the beginning and end of each segment file 40, may be provided manually by an operator using, for example, a mouse or keyboard (none shown) of computing device 16, or automatically by audio sensing equipment as is further described below. In certain embodiments of the invention, editing software 38 of computing device 16 is used by an operator to edit the content of segment files 40, thereby creating edited segment files 44, as is also further described below.

Master recorder 18 may include a storage device 46 (such as a hard drive) for storing edited segment files 44 created using editing software 38 of computing device 16 and received via a wired or wireless connection to computing device 16, as well as a plurality of media receptacles 48 for receiving a plurality of media 50. Although the scope of this invention covers any of a plurality of different commercially available media (e.g., CDs, cassettes, and other content storage devices now known or later developed), the remainder of this specification will refer to CD media for purposes of simplifying the description of the invention. Accordingly, media 50 for use with master recorder 18 will hereinafter be referred to as a master CD 50 or MCD 50. Various different master recorders 18 may be used including a Tascam® CDRW2000 or an Echostar® brand master recorder. As is further described below, master recorder 18 also includes controls 52 for enabling an operator to simultaneously copy edited segment files 44 stored on storage device 46 onto each of MCDs 50, thereby creating a plurality of master copies. Of course, in other embodiments of the system, computing device 16 may be used to create a single MCD 50, and master recorder 18 may be used to duplicate the single MCD 50 onto a plurality of MCDs 50. Alternatively, computing device 16 and master recorder 18 may be combined or otherwise configured such that edited segment files 44 are written directly onto a plurality of MCDs 50, in either a disc-at-once or track-at-once mode. In yet another alternative embodiment, master recorder 18 (or computing device 16) may be configured such that it creates a single MCD 50, which is replicated onto final CDs as is further described below.

Each of the plurality of duplicators 20 may include a plurality of media receptacles 54 for receiving a plurality of media such as, for example, CDs (hereinafter referred to as final CDs 56 or FCDs 56). Each duplicator 20, in one embodiment of system 10, also includes a master media receptacle 58 for receiving an MCD 50. Various conventional duplicators 20 may be employed as duplicators 20 including those made by Microboards Technology, LLC of Minnesota. As will be further described below, each duplicator 20 further includes controls 60 for copying the contents of MCD 50 onto the plurality of FCDs 56, thereby creating a plurality of final copies.

It should also be understood that in other embodiments, duplicators 20 may be configured such that some or all of duplicators 20 read from a single MCD 50 and simultaneously copy to some or all of the FCDs 56. For example, six duplicators 20, each having seven media receptacles 54, could be configured to read from a single MCD 50 located either in master recorder 18, in one of duplicators 20, or in another output device. In this manner, forty-two FCDs 56 can be created simultaneously. In another example, three duplicators 20 may be configured to read from one MCD 50, while another three duplicators 20 are configured to read from another MCD 50. Such a setup may be less efficient in that more than one MCD must be loaded to make the same forty-two final copies, but the redundancy of multiple MCDs 50 also reduces the risk of creating a large quantity of defective FCDs 56. More specifically, where one (or a relatively small number) of MCDs 50 are used to create FCDs 56, a relatively small amount of time is needed to load the MCDs 50, but a defect in one of the MCDs 50 may result in a relatively large number of defective FCDs 56. On the other hand, when a larger number of MCDs 50 are used to create FCDs 56, a relatively large amount of time is needed to load the MCDs 50, but a defect in one of the MCDs 50 may result in a relatively small number of defective FCDs 56. Depending upon the expected demand for recordings of the event, the number of people available to load MCDs 50, and other variables, the service provider may configure system 10 to optimize the speed of the duplication and the risk of producing defective FCDs 56.

Duplicators 20 may be housed in cases to protect duplicators 20 during loading and unloading, and during use at the event. Each case may house a plurality of duplicators 20 and include casters or wheels to render the cases more easily moved during setup and tear down of system 10. Each case may further include backup power supplies (not shown) to ensure uninterrupted operation even in the event of an interruption of power supplied by the venue, and fans (not shown) or other cooling devices to ensure that the plurality of duplicators 20 are not damaged by excessive heat generated during operation. As is further described below, duplicators 20 may alternatively be housed in a vehicle such that duplicators 20 are not loaded or unloaded for operation. In one embodiment, duplicators 20 are housed within a tour bus or a trailer. In this manner, duplicators 20 need not be separately transported from event to event during a tour in which the service of the present invention will be provided at multiple events. As such, the service provider may reduce setup time of system 10, and provide the personnel of the service provider more time to sleep as the personnel travel from event to event.

It should be understood that using any of the embodiments described herein, the service provider may, in addition to creating and distributing copies of recordings of the performance, provide or facilitate the provision of a substantially simultaneous broadcast an audio component of the performance. In this manner, the service provider may take advantage of conventional technology for providing a streaming audio signal or simultaneous webcast that may be received, for example, over the internet or other suitable network by authorized recipients. Conventional methods for providing reception authorization are well-known in the art.

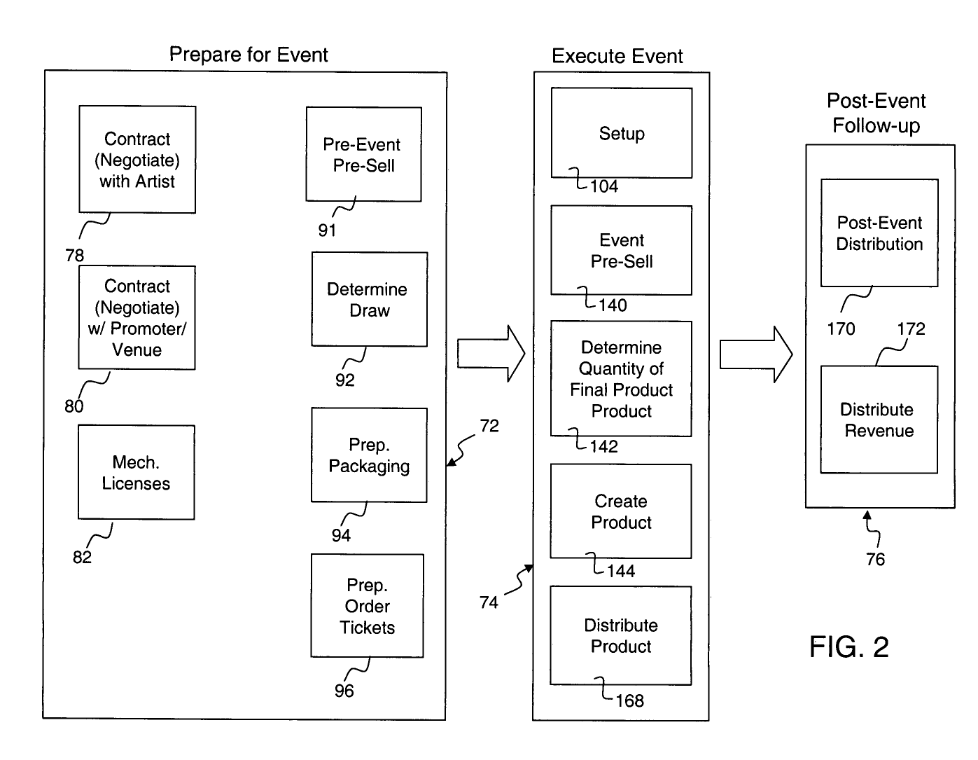

FIG. 2 generally depicts three stages of activity carried out in the course of practicing one embodiment of a method according to the present invention. More specifically, the service provider may prepare for the event by contracting with the relevant parties, obtaining rights to make and distribute recordings, and preparing the materials and information relating to the event as depicted in block 72, execute the event as depicted in block 74, and conduct post-event follow up activities as depicted in block 76.

As shown in FIG. 2, prepare for event stage 72 may include the steps of negotiating and contracting with the artist (block 78) (directly or through the artist's management or booking agency) and contracting and negotiating with promoters and/or venue personnel (block 80), obtaining mechanical licenses (block 82), determining a draw for the event (block 92), preparing packaging for the event (block 94), and preparing order tickets for the event (block 96). Regarding contracting steps 78, 80, in general, the promoter negotiates the terms and conditions for the provision of the content of an event or performance with the management and/or booking agent of the performing artist, and with the venue's representatives to secure the venue for the event. These terms and conditions are typically incorporated into two agreements involving the promoter, one for the artist's services and one for the venue. The artist's technical requirements for production of an event are typically incorporated into the agreement between the artist and the promoter (commonly referred to as a technical rider or “rider”). Since the artist often has no direct contractual relationship with the venue, the promoter may be responsible for obtaining the venue's compliance with rider requirements. In other situations, the service provider, the artist's management, or the booking agent may be responsible for ensuring the venue's compliance. While the service provider of the present invention typically negotiates with both the artist and the promoter and/or venue, the scope of the present disclosure and appended claims is sufficiently broad to cover situations wherein the service provider is owned or controlled by the venue, the promoter, or the artist. Referring to step 78, where an artist is interested in utilizing the service provided through use of the present invention, the service provider may negotiate with the artist to determine the payment to the artist per unit of final product distributed (further described below), and to ensure that the artist incorporates into the rider or otherwise in the agreement with the promoter, requirements that the venue provide certain resources to facilitate execution of the event. As is explained in detail below, these resources may include power sources and cabling for gear, personnel to perform certain tasks (such as stage hands, road crew, and security) before, during and after the event, dedicated space for gear and point-of-sales (POS) location(s), dedicated routes between gear and POS location(s), secure cash depositories, and sales tax processing services. In this manner, the artist may, through its negotiations with the promoter, or less commonly with the venue, ensure that all of the resources needed to successfully and safely execute the event will be made available to the service provider at the venue as and when needed.

Additionally, the service provider may negotiate with the artist to obtain cooperation in the service provider's provision of the present service from the artist, its representatives, engineers and technicians. For example, the service provider may require the artist to instruct the artist's soundperson to assist the service provider in capturing a quality live feed from the venue equipment and/or the artist's mixing board (e.g., front of house console 22) and making amplified sound level adjustments to optimize recording levels. Moreover, the service provider may require the artist to announce to attendants of the event, for example, near the beginning of the event and/or near the end of the event, the availability of recordings of the event for sale. Finally, the service provider may require the artist to grant the service provider the appropriate licenses to use certain of the artist's trademarked or copyrighted material and/or rights of publicity including, for example, any logos, names, photographs, biographies, tour slogans, tour titles, sponsors, etc., on advertising for the service provider and on the final products.

Referring now to step 80, in addition to or as part of the above-described negotiations, the service provider may also negotiate with unionized labor personnel employed or contracted by the venue to ensure that such personnel will be deployed in a manner consistent with any applicable union policies or practices. Moreover, if not governed by the artist's agreement with the promoter, the service provider may negotiate directly with the venue to obtain rights to sell merchandise in and around the venue and to establish the terms and conditions that govern those rights. For example, if the venue will grant such rights, it typically requires a percentage of the sales revenue from final products as a “house fee.”

As indicated above, prepare for event stage 72 may further include a plurality of activities that are carried out after the event is scheduled and the terms and conditions governing the provision of the service are substantially established. One group of activities is depicted by block 82 wherein the scope of mechanical copyright licenses is identified and licenses are obtained. The following discussion of mechanical licenses is, of course, applicable to the making and distribution of phonorecords of nondramatic musical works.

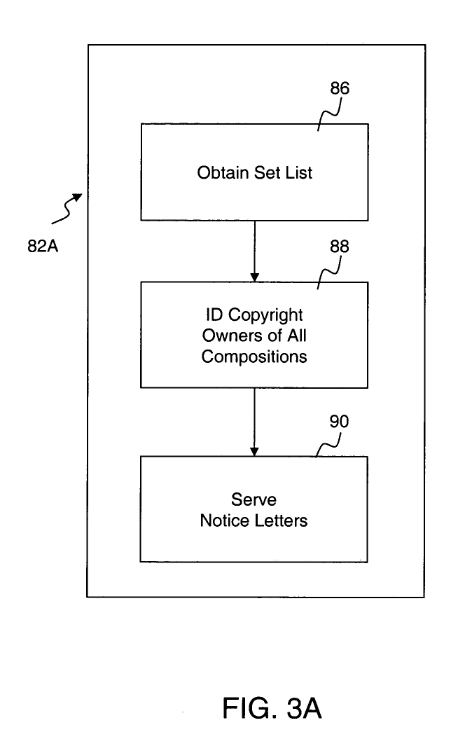

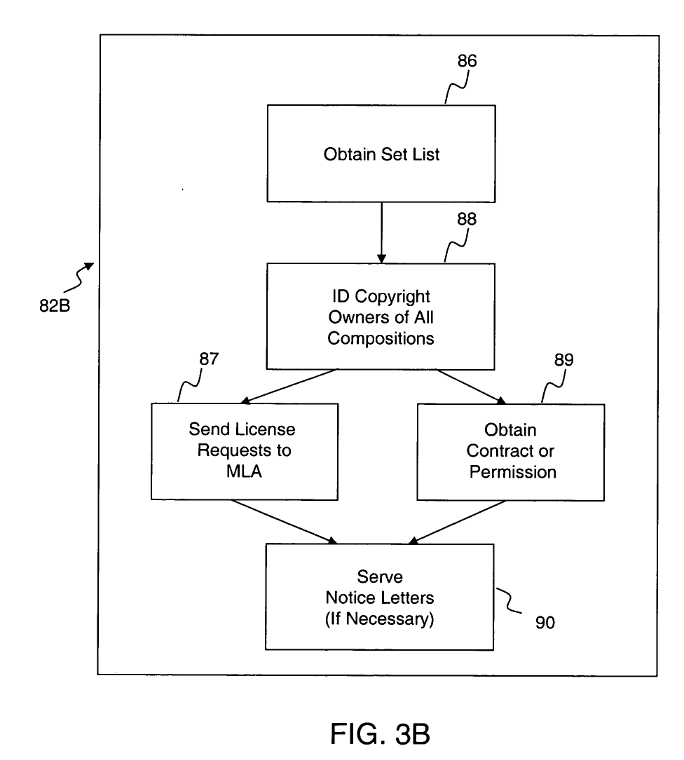

Multiple steps may be included in block 82 as illustrated by the two embodiments of FIGS. 3A and 3B. Referring first to FIG. 3A, the service provider or a mechanical license clearinghouse organization (MLC) engaged by the service provider, may obtain information from the artist or the artist's management including a set list for the event (block 86). The set list includes a listing of any non-controlled compositions (i.e., compositions in which the artist does not own all of the copyrights) usually referred to as “cover songs” (i.e., songs previously released by another artist) the artist plans to perform at the event, as well as a listing of all controlled compositions (i.e., compositions in which the artist or its record label owns the copyrights and is willing to grant the service provider permission to make and distribute copies). Additionally, the set list may include an estimate of time duration of each composition on the set list. Of course, the service provider may determine this information and provide it to the MLC and/or obtain mechanical licenses directly, without the assistance of the MLC. In either case, the MLC (or the service provider) also identifies the copyright owner(s) of the controlled compositions, including their address and federal ID number, and researches any cover songs to determine contact information of the copyright owner(s) of those compositions (block 88).

It should be understood that the service provider may require the artist (during step 78 of FIG. 2) to agree to perform only those compositions identified in the set list (i.e., identified cover songs and controlled compositions). Moreover, the service provider may require the artist to agree that it will not alter the basic melody or fundamental character of cover songs or seek protection of its performance of such materials as a derivative work under the Copyright Act.

Next, at some time before the event, the MLC (or the service provider) may serve upon the appropriate copyright owners or their representatives (collectively, “copyright holders” or “holders of copyrights”) notice letters of the service provider's intention to obtain compulsory licenses to the compositions expected to be performed at the event (block 90). Such notice letters may include a variety of different types of information including the name and address of the licensee, a statement of the nature of the business the licensee will use in making and distributing copies of the compositions, specific corporate officer information if the licensee is not a public corporation, the type of fiscal year used by the corporate licensee, the titles of the works to be distributed under the compulsory license and the names of the authors, the type of physical embodiment to be distributed (e.g., single disks, long-playing disks, cassettes, etc.), the date of initial distribution, the name of the artist that will actually perform the works, and the catalog number(s) and label name(s) to be used. In addition, the notice letters are signed by the licensee (or an officer thereof), and either filed at the copyright office (if the copyright owner is not identified in the public records, is not located at a last known address, or refuses service of the notice) or sent by registered or certified mail to the copyright owner.

In an alternative embodiment depicted in FIG. 3B, steps 86,88 are substantially the same as those described above. In step 87, the MLC or the service provider may proceed through a mechanical licensing agency (hereinafter, an “MLA”) and, after determining certain information relating to the artist, the compositions, the publishers, and the intended distribution of copies, send a mechanical license request form to the MLA to request permission to make and distribute copies of the compositions to be performed at the event. One example of an MLA is The Harry Fox Agency, Inc., which acts as an information source and agent for owners of musical copyrights. In response to such a request, the MLC or the service provider may receive permission from the MLA (originally granted to the MLA by the copyright owner(s) or their representatives) to make and distribute recordings of compositions. It should be noted, however, that it may be desirable to forward such requests for permission to the MLA sufficiently in advance of the event so that the MLA has time to grant permission or to inform the MLC or the service provider that the MLA does not have authority to grant permission for certain compositions. In the event the MLA does not have authority to grant a mechanical license for a composition, the MLC or the service provider may generate and serve on the appropriate copyright owner(s) or their representative a notice letter in the manner described above (block 90).

As is also shown in FIG. 3B, the MLC or the service provider may obtain directly from the copyright owner(s) or their representative, contractual permission to make and distribute recordings of compositions controlled by the owner(s) or their representatives (block 89). As should be apparent from the foregoing, this avenue of obtaining rights to make and distribute copies may be pursued in place of, in parallel with, or in series with step 87. In the event permission is not obtained as a result of step 89, the MLC or the service provider may then serve notice letters in the manner described above (block 90). As will be further described below, the process for computing and distributing royalty payments is carried out after the event is executed.

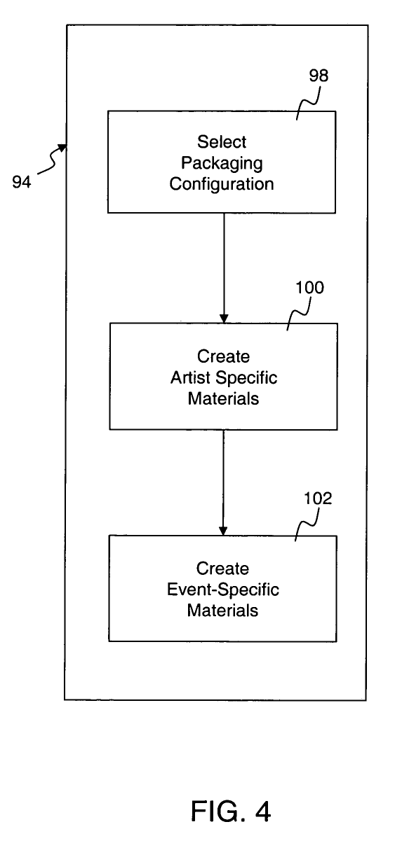

Referring back to FIG. 2, during prepare for event stage 72, the service provider may communicate with the promoter, the venue and/or the artist to determine an estimated attendance or draw (block 92) for the event based upon venue size, their past experience in drawing attendees, etc. Based upon this estimated draw, the service provider may prepare packaging materials for the event as indicated by block 94, and may prepare a quantity of order tickets as indicated by block 96. FIG. 4 depicts the various sub-steps included in prepare packaging block 94 of FIG. 2.

Referring to FIG. 4, the service provider may (subject to applicable contracts) first select the packaging configuration for the final product as indicated by block 98. Various different types of packaging configurations may be suitable including jewel cases, envelopes, or standard and tri-fold sleeves. The type of packaging configuration selected may determine the artist-specific materials created at block 100. For example, if jewel case packaging is selected, the service provider may print or otherwise create (or have created) liner note type inserts identifying the artist and including, for example, trademarks, artwork, photographs, and any other relevant information. If a sleeve is used, the service provider may print or otherwise create (or have created) the sleeve itself such that the sleeve identifies the artist and contains the artwork and any other relevant information.

It should also be understood that if the service provider and the artist have agreed that the service of the present invention will be provided for a plurality of events (e.g., an entire tour or part of a tour), then the artist-specific materials will likely include relatively generic artist information that applies to each of the plurality of events such as, for example, the name of the artist, the name of the tour, the name of the material forming the basis of the tour, the names of members of the band, tour logo, artist logo, sponsorship(s), etc. If, on the other hand, the service will be provided for a single event, then more specific information may be included on the packaging such as the name of the venue, the date of the event, etc., as indicated by block 102. Other event-specific materials may include stickers for attachment to the more generic, artist-specific materials to identify, for example, the names of the venues and the dates of the individual events recorded during the course of a tour. Any of the above-identified packaging materials may readily be imprinted with a bar-code label for use in tracking inventory and facilitating distribution of final products as is further described below.

As indicated above, prepare order tickets step 96 of FIG. 2 may be carried out during prepare for event stage 72 of the present invention. As is further described below, the order tickets may be used to facilitate pre-event selling of the final products, both before the day of the event and on the day of the event. That is, before the event is completed, the service provider may give an attendee an order ticket in exchange for the purchase price of the final product. In this manner, the service provider is able to determine the number of final products to produce during the event to satisfy the pre-established demand as well as the anticipated quantity of units to indicate in mechanical license requests. Of course, the service provider may produce a number of additional final products to distribute to attendees who did not pre-pay, but wish to purchase a final product at the venue after the event. Additional copies may be produced for archival purposes and/or to satisfy demand realized through alternative distribution channels such as on-line sales, telephone sales, catalogue sales, sales at future events, sales at retail outlets, or other modes of distribution used after the day of the event as is further described below.

In another embodiment, order tickets are not prepared in advance of the event. Instead, one or more cash register-type devices are used at the event to process purchases of final products. After payment for the final product is received, the device prints out a bar-coded receipt for the attendee who purchased the final product and maintains a count of pre-sold final products. This count may be used by the service provider to determine a number of final products to create in the manner described herein. After the event, the attendee provides the bar-coded receipt to the service provider who, using a bar-code scanner, reads the receipt to verify the purchase and provides the attendee with a final product.

As indicated by-block 91 of FIG. 2, prepare for event stage 72 may include pre-event pre-selling of final product. Various techniques for such pre-event pre-selling are possible including sales on-line, via telephone, or by mail or other mode of communication. In such an embodiment, the service provider may advertise upcoming events on, for example, a service provider website or, by agreement, the artist's or promoter's website, and facilitate pre-event pre-selling of final products for specific events using secured credit card transaction technology that is well-understood in the art. Alternatively, the service provider may process phone orders or mailed orders for final products of specific events, before the events actually occur. Another alternative is pre-event pre-selling in conjunction with on-line ticket sales by agreement with a ticketing company as is further described below. Purchasers of final products via these alternative methods of sales may be provided a receipt, voucher, claim number, or other item or piece of information that will facilitate verification of the sale so that the purchasers can claim their final products after the event.

Yet another alternative embodiment includes the step of offering a purchaser of a ticket to an event the opportunity to pre-purchase a final product corresponding to the event with the ticket purchase. In this manner, the infrastructure necessary to sell tickets to events may be employed to simultaneously sell final products. In this embodiment, a portion of the ticket may include a claim number or other indicator that the attendee has pre-purchased a final product. The attendee may present this portion of the ticket to the service provider to receive a final product after the event. As should be apparent from the foregoing, if a ticking company is used to provide pre-event pre-selling in this manner, then the service provider will also have negotiated a requirement (e.g., via the artist agreement discussed above) that the ticketing company report pre-event pre-sales to the service provider to enable the service provider to create a sufficient quantity of final products to meet the overall demand for final products. Of course, the service provider (or ticket sales organization) may offer discounts on one or both of the ticket and the final product if the two are purchased simultaneously. Indeed, in the other described embodiments, the service provider may offer a discount on pre-purchased final products vs. final products purchased after the event, or vise-versa.

Prepare order tickets step 96 of FIG. 2 may be carried out in a variety of different ways. For example, a quantity of event-specific order tickets that identify the artist, the date of the event, the venue, etc., may be printed for distribution in the manner described above. The quantity will typically be a percentage of the estimated draw for the event that corresponds to the number of final products the service provider expects to distribute at the event. Alternatively, pre-printed, generic raffle-type tickets may be used. In both of these configurations, a portion of the ticket may be retained by the service provider to facilitate counting of the pre-established demand for final product, while another portion of the ticket may be retained by the attendee and turned in to the service provider at a POS site after the event to redeem the attendee's final product as is further described below. According to another embodiment, a plurality of re-usable (e.g., laminated) cards may be used instead of order tickets. If re-usable cards are employed, an attendee may be provided with a card in exchange for the purchase price of the final product, and the service provider may simply keep track of the distribution of cards to facilitate counting of the pre-established demand. The attendee may then give the card back to the service provider at a POS site to claim his or her final product as is further described below.

Execute event stage 74 of FIG. 2 also includes several individual steps. Setup step 104 encompasses setup of gear and other materials useful in carrying out the present method. This step may require agreement with the artist, and for major productions, this step may need to be carefully coordinated with the setup of the artist's gear, which typically includes assembling a complex sequence of rigging and cabling, and testing an array of lighting, sound, video and pyrotechnic equipment. The gear contemplated by step 104 is depicted in block diagram form in FIG. 1, and, as described above, varies depending upon the embodiment of the invention. In general, the service provider may set up input processor 12 for communicating with front of house console 22, computing device 16 and master recorder 18 for creating MCDs 50, and duplicators 20 for creating FCDs 56 for distribution. In an alternate embodiment, computing device 16 is omitted to simplify the setup and operation of the system as will be further described below.

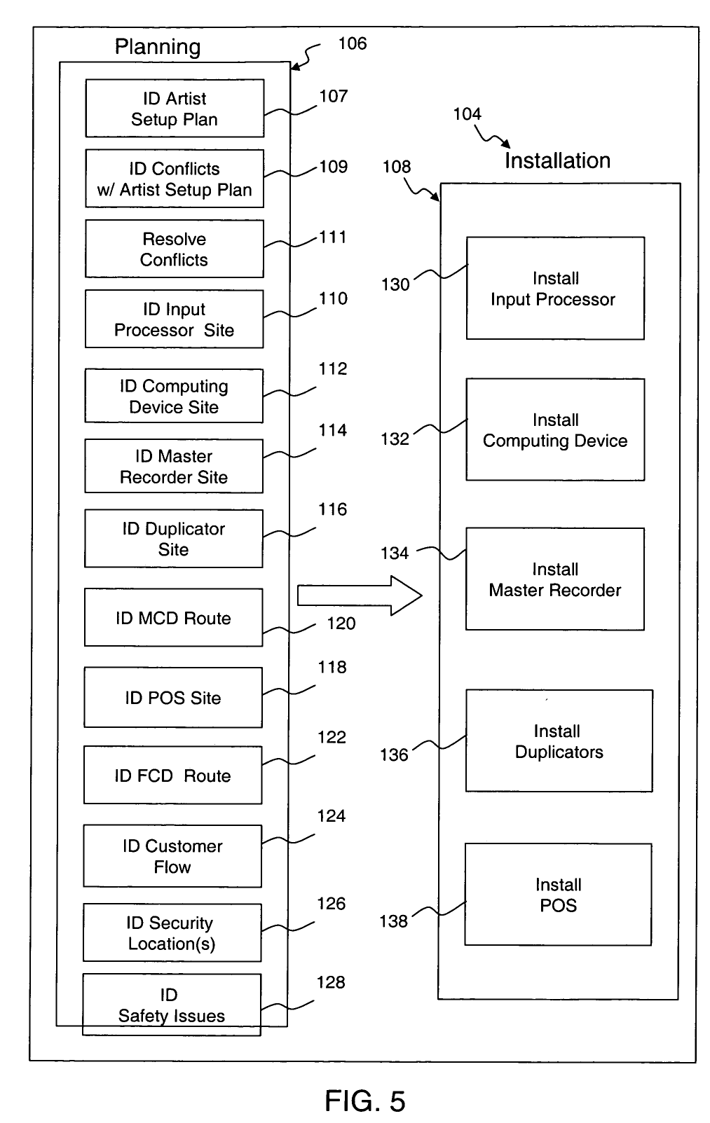

Referring now to FIG. 5, setup step 104 of FIG. 2 is depicted as including two stages of activity, a planning stage (block 106) and an installation stage (block 108). In planning stage 106, the service provider first determines the times, locations, and sequence for the setup of artist's gear (block 107) so that any conflicts with the service provider's schedule (or locations) can be identified (block 109). The service provider then identifies by reference to contracts and other information, the authorized representative of the artist, the promoter, and/or the venue who is able to resolve setup scheduling issues and establish approved time periods and installation sequences for its gear (block 111).

The service provider identifies an acceptable location for input processor 12 (block 110). In one embodiment, input processor 12 is located adjacent front of house console 22 and is configured for communication therewith in the manner described above. In other embodiments, input processor 12 is mobile, mounted in a truck or other vehicle, or otherwise remotely located from front of house console 22. The service provider may also identify an acceptable location for computing device 16 (block 112), depending upon the embodiment of the invention deployed, which may be adjacent input processor 12 or at some other site remote from front of house console 22. Similarly, the service provider may identify acceptable locations for master recorder 18 (block 114) and duplicators 20 (block 116).

As is further described herein, duplicators 20 may include a plurality of relatively expensive duplication devices which (unlike input processor 12, computing device 16, and master recorder 18 in certain embodiments of the invention) may not be located in proximity to front of house console 22 (i.e., in a protected area secured for sound equipment). Accordingly, the identified duplication site may be a securable area, not generally accessible by the event attendees, such as a locked room or corded off area within the venue. As is also described herein, the duplication site may be remote from the venue interior, such as, for example, in a vehicle located outside the venue. It should be noted that the duplication site may be selected such that a final product assembly area is at or near duplicators 20. In this manner, as FCDs 56 are created, they may be packaged for transport to the POS site.

As depicted by block 118, the service provider also identifies an acceptable POS site which may be in a lobby or hallway of the venue. In many instances, it is desirable to locate the POS site at a location adjacent a primary route of travel of attendees, such as in a hallway or foyer of the venue through which the attendees will travel as they enter and exit the event. Such a location facilitates effective advertising of final products and attendees who did not pre-purchase a final product may be more likely to see the POS site and purchase a final product as they exit the event.

In the process of identifying the location of master recorder 18 (block 114) and the location of duplicators 20 (block 116), the service provider may, depending upon the embodiment of the invention deployed, also identify an MCD route (block 120) between input processor 12 and duplicators 20. In one embodiment, MCDs 50 created using master recorder 18 are hand-carried from the location of master recorder 18 to the location of duplicators 20. As will become apparent from the description of the operation of system 10 of FIG. 1, it may be desirable to identify an MCD route that will permit rapid movement of MCDs 50 from master recorder 18 to duplicators 20.

Similarly, in the process of identifying the location of duplicators 20 (block 116) and the location of the POS site (block 118), the service provider may identify an FCD route (block 122) that may be used to hand-carry FCDs 56 from duplicators 20 to the POS site for distribution to attendees. Again, it may be desirable to identify an FCD route that will facilitate rapid transfer of FCDs 56 to the POS site. It should also be understood that the assembly area need not be located at the duplication site, and that the duplication site may be adjacent the POS site, thereby eliminating the need to identify an FCD route.

Various other steps are involved in planning stage 106 as shown in FIG. 5. For example, when identifying the POS site (block 118), it may be desirable to identify a customer flow (block 124) that facilitates rapid movement of attendees toward and away from the POS site. In this manner, attendees may quickly move toward the POS site to obtain their final products, and then quickly move away from the POS site so as not to cause congestion (and therefore slower movement) of attendees toward and away from the POS site. Additionally, the service provider may identify locations for security personnel (block 126), such as adjacent the POS site and adjacent the locations of the various equipment. Finally, the service provider may identify any potential safety issues (block 128) including fire hazards, crowding hazards, etc.

Upon completion of planning stage 106 (or after completion of one or more steps of planning stage 106), the service provider may perform installation stage 108 of the present method. As shown in FIG. 5, installation stage 108 may include, depending upon the embodiment of the invention deployed, the steps of installing input processor 12 (block 130), installing the computing device 16 (block 132), installing master recorder 18 (block 134) installing duplicators 20 (block 136), and installing the POS materials (block 138). Installation and operation of the various pieces of equipment is described throughout this specification. Installation of the POS materials may include setting up a merchandising table, signage, catalogs, or other advertising materials, credit transaction devices, cash registers, and storage containers for final products.

Referring back to FIG. 2, event pre-sell step 140 of execute event stage 74 entails the activity of obtaining the purchase price of the final products from event attendees at the event, but before the event is completed (as contrasted with pre-event pre-sell step 91 described above). More specifically, the service provider may, at the POS site, provide order tickets in exchange for payment of final products as attendees enter the venue. The service provider may also move to other locations in and around the venue to pre-sell final products. For example, the service provider may, using wireless credit card devices, move through the venue performance area, the venue entrance area, areas outside the venue where attendees typically wait to enter the venue, venue parking lots, or other such locations to offer final products for sale. By making credit card sales in this manner, the service provider may avoid the risks associated with carrying large quantities of cash and the inconvenience of having to make change. Of course, in an alternate embodiment, the service provider may carry cash to facilitate cash transactions instead of, or in addition to, credit card transactions.

Regardless of how pre-sell step 140 is carried out (i.e., one or more of the alternatives described above), the service provider may use the total pre-sold quantity of final products as a factor in determining the quantity of final products to create during the event as indicated by block 142. For example, if 500 final products were pre-sold, the service provider may determine, based on past experience or otherwise, that 750 final products should be created to accommodate an anticipated post-event demand (i.e., purchases made after the event at the venue) of 50% of the pre-event demand. Alternatively, the service provider may determine that 800 final products should be created to accommodate a 50% post-event demand and a 10% alternative distribution demand (i.e., purchases made after the day of the event via on-line sales, phone sales, mail order sales, etc.).

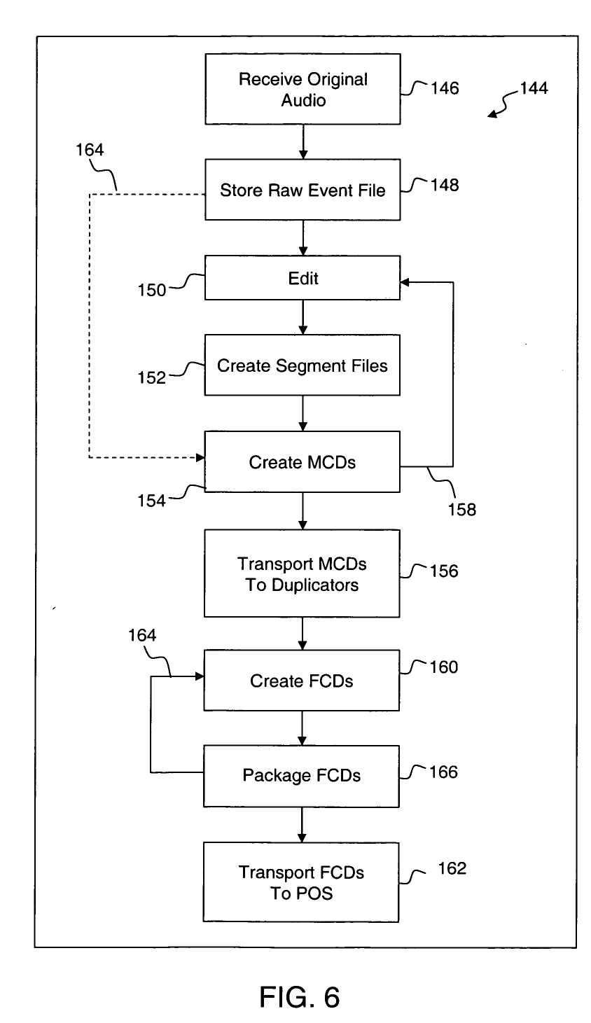

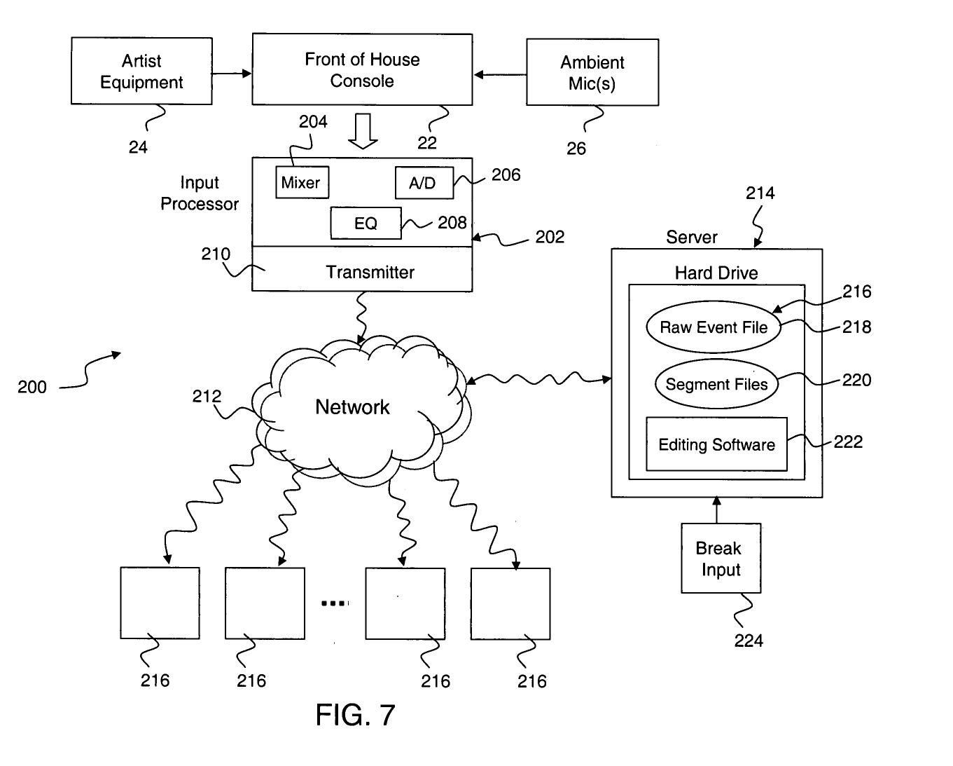

The next step in execute event stage 74 is the create product step 144. Various sub-steps are included in create product step 144 as illustrated in FIG. 6. Depending upon the embodiment of the invention deployed, step 146 of receiving the original audio signal may include the use of input processor 12 to convert the signal from analog to digital form using A/D converter 30, to mix channels of the signal using mixer 28, and/or to adjust the levels of various components of the signal using EQ 32. Step 146 may further include transmitting the processed signal (i.e., the original audio signal as processed in the manner described above) to computing device 16, as will be further described below, for storage as raw event file 36 on, for example, hard drive 34 as indicated by block 148. A backup copy of the processed input signal may also be transmitted to backup recorder 14 for storage on hard drive 15 or CD 17. In this manner, if for some reason raw event file 36 is damaged or corrupted in any way, the backup copy of the event stored on hard drive 15 or CD 17 may be copied to hard drive 34 of computing device 16 to restore raw event file 36.

Raw event file 36, in one embodiment of the invention, may be edited as suggested by block 150 of FIG. 6. In editing step 150, a technician or operator of the service provider may provide break inputs 42 to computing device 16 to indicate transitions or chapter breaks between discrete segments as those discrete segments are performed and added to raw event file 36. More specifically, in one embodiment of the invention, the operator may provide a break input 42 to computing device 16 after a song performed during the event is completed. A segment file may alternatively be defined as a plurality of songs (or other units of entertainment) performed as a group or in a related series such as a suite or medley. If computing device 16 is in a location that is remote from the artist during the event, a video signal may be provided to the operator to assist the operator in making the manual assessment that a song, for example, is completed. This component of editing step 150 may be carried out manually in the manner described above, or automatically using, for example, software that detects changes in levels of certain components of the processed signal that indicate the completion of one segment of the performance and/or the beginning of another segment. In either event, raw event file 36 may, as a result of defining such chapter breaks, be copied into segment files 40, each containing content representing a segment of the performance, as indicated by block 152 of FIG. 6. It should be understood that such segment files 40 are created substantially in real time during the performance of the event.

Editing step 150 may also include a content editing step wherein an operator or technician of the service provider alters the content that is ultimately stored in segment files 40. More specifically, the technician may employ conventional or custom editing software 38 to remove undesirable material (e.g., undesirable noises of the attendees, pops or other undesirable sounds from equipment, undesirable comments by the artist, long periods of content having little or no entertainment value, etc.), to fade into and/or out of segments, enhance certain audio components of segment files 40, or to otherwise affect the final content of segment files 40. For each segment file 40, the output of such editing software 38 is stored as an edited segment file 44 on, for example, hard drive 46 of master recorder 18.

As will become more apparent from the following description, segment files 40 (and edited segment files 44) are created substantially in real time as the artist completes segments of the performance at the event. Although, as discussed above, the service provider has, at this point in practice of the method, obtained a set list from the artist, it is certainly possible (if not probable) that the order and/or duration of the segments deviate from the set list. One consequence of such deviation is that the service provider cannot, with accuracy, plan the content of each MCD 50. On this point, it is well known that standard recording media suitable for distribution (i.e., CDs, cassette tapes, etc.) can store only a certain amount of content (in terms of minutes of recording) without resulting in an unacceptable degradation of quality. For example, a conventional CD generally contains approximately 75 minutes of recorded material. The service provider can, based on the set list, estimate which edited segment files 44 will be present on which MCDs 50 (assuming an event that exceeds 75 minutes and results in a multi-CD final product), with the goal of avoiding a split of a segment file 44 between two different MCDs 50 and a further goal of storing the minimum content on the final MCD 50 of a set (for reasons that will become apparent from the following discussion). Deviations (in order or duration) from the set list, however, may require the technician at editing step 150 to determine the content of each MCD 50 such that edited segment files 44 actually stored on each MCD 50 (as described below) is different from the edited segment files 44 expected to be stored on each MCDs 50 based on the set list. This type of editing may also be included in editing step 150 of FIG. 6.

Create MCDs step 154 of FIG. 6 may include the steps of copying individual, edited segment files 44 onto an MCD 50 as each edited segment file 44 is completed. Alternatively, a plurality of edited segment files 44 (corresponding to the desired content of a particular MCD 50) may be copied onto an MCD 50 in a single copying operation. Of course, edited segment files 44 may also be copied to multiple MCDs 50 to facilitate more rapid production of FCDs 56, as is further described below. It should also be understood that, in one embodiment of the invention, edited segment files 44 may be copied to a master file stored, for example, on hard drive 46 of master recorder 18, which in turn is copied via a communication interface (e.g., a wired or wireless network) to duplicators 20 to make FCDs 56. Of course, it is also within the scope of the present invention to provide for copying individual, edited segment files 44 via such a communication interface directly to duplicators 20, without creating a master file of any kind. In any of these embodiments, creation of MCDs 50 may optionally include the step of inserting copyright protection technology according to principles that are well known in the art.

As is further described below, depending upon the system used to execute create product step 144, some or all of the above described editing may be omitted as indicated by the dotted line 149 shown in FIG. 6.

As indicated above, in one embodiment of the invention, edited segment files 44 are copied onto a plurality of MCDs 50 during create MCDs step 154. In this embodiment, after each set of MCDs 50 is completed, an operator of the service provider transports the MCDs 50 to duplicators 20 as indicated by step 156 of FIG. 6. This transportation step 156 may take advantage of the MCD route identified in step 120 of the setup step 104 described above. By transporting MCDs 50 to the duplication site immediately after each set of MCDs 50 is created (again, assuming an event that exceeds approximately 75 minutes), the service provider is able to perform the process of duplicating the MCDs 50 as the event is occurring and while the service provider is in the process of creating the next set of MCDs 50 as is indicated by return arrow 158 of FIG. 6. In this manner, final product can be made available very soon after completion of the event since the only duplication that will be necessary at the completion of the event is duplication of the final set of MCDs 50, which (where possible) contain the least amount of content of all of the MCDs 50 created during a multiple MCD 50 event.

After MCDs 50 are transported to the site of duplicators 20, the step of creating FCDs 56 is performed as indicated by step 160 of FIG. 6. As described above, a variety of different duplication setups are suitable for practice of the present invention. In one embodiment, an MCD 50 is placed into receptacle 58 of each duplicator 20. Each duplicator 20 may be configured to simultaneously create (by copying the content of MCD 50) a plurality of FCDs 56. Of course, the more FCDs 56 produced by each duplicator 20, and the more duplicators 20 used at the duplication site, the more FCDs 56 (and final products) that can be produced per unit of time.

After each set of FCDs 56 is created (i.e., after each set of MCDs 50 is duplicated), that set of FCDs 56 may be packaged (as indicated by step 166 described below) and transported to the POS site(s) as indicated by step 162 of FIG. 6. This transportation step 162 may take advantage of the FCD route identified in step 122 of setup step 104 described above. By packaging FCDs 56 immediately after each set of FCDs 56 is created (again, assuming an event that exceeds approximately 75 minutes), the service provider is able to perform packaging steps as the event is occurring and while the service provider is in the process of creating the next set of FCDs 56 as indicated by return arrow 164 of FIG. 6. In this manner, a complete set of final products of the event can be made available very soon after completion of the event since the only packaging that will be necessary at the completion of the event is packaging of the final set of FCDs 56.

The packaging step 166 of FIG. 6 includes the process of inserting the FCDs 56 into the packaging materials prepared during step 94 of prepare for event stage 72 depicted in FIG. 2. Additionally, at the conclusion of the event (or during the event), the service provider may prepare a final listing of segments (e.g., songs) performed at the event. This listing may be inserted into or affixed to the packaging to provide the purchaser with a table of contents of the final product. Alternatively, the service provider may burn the listing directly onto FCDs 56. Additionally, event-specific materials created during step 102 (FIG. 4), if any, may be assembled into the packaging of the final products.

Referring again to FIG. 2, the final step of the execute event stage 74 is the distribute product step 168. In this step, the service provider receives bar-coded receipts, order tickets (or the equivalent as described above) at the POS site from attendees who pre-purchased final products. In exchange for the bar-coded receipts or order tickets, the attendees are provided a corresponding number of final products and the distribution transaction is complete. Alternatively, the service provider may receive payments (cash, check, charge, etc.) at the POS site from attendees who did not pre-purchase final product during pre-sell step 140 described above. In exchange for these payments, the service provider provides the attendees with a corresponding number of final products and the distribution transaction is complete. This is a form of post-event distribution 170 of FIG. 2, which is further described below.

Post-event follow-up stage 76 of FIG. 2 includes post-event distribution of final product step 170 and distribution of revenue step 172. In addition to the post-event distribution described above, post-event distribution of final product step 170 may include distribution of final product to the artist for future sale, as well as distribution by the service provider directly, through retail outlets as CDs, or as various forms of digital phonorecord deliveries directly or through others. Moreover, in the manner described above with reference to pre-event pre-selling step 91 of FIG. 2, the service provider may distribute final products in exchange for payment (or otherwise) as a result of on-line orders, phone orders, mail orders, demand at future events, etc.

Distribute revenue step 172 includes payment of revenue to the venue if the merchandising rights obtained from the venue were negotiated (in steps 78 or 80 of FIG. 2) in exchange for a percentage of revenue from sales of final product at the venue. Step 172 may further include payment of revenue to the artist of the negotiated percentage of revenue from sales. As should be apparent from the foregoing, payment to the artist may occur on a periodic basis (the first corresponding to the quantity of final products distributed on the day of the event) as additional final products are distributed during post-event distribution step 170 described above. In conjunction with such distributions or as otherwise agree, the service provider may render periodic accountings to the artist.

Step 172 may further include payment of royalties due under the mechanical licenses obtained in step 82 during prepare for event stage 72 of FIG. 2. Like the payments to the artist, the royalty payments under the mechanical licenses may occur on periodic schedules in accordance with the provisions applicable to the particular mode of acquiring the license. Such modes include contractual acquisition by agreement with the copyright holder directly, agreement with an MLA, or statutory acquisition of compulsory licenses in the manner described above. In any event, for compositions to which the artist is not the copyright owner (e.g., cover songs), the payments may be made by the service provider directly to the copyright owner(s) or indirectly through an agency as described above. The royalty rate is calculated based on the applicable statutory royalty as is well known in the art. For example, each final product distributed containing cover song X may result in a payment by the service provider to the copyright owner(s) of 8.5 cents or 1.65 cents per minute of playing time of cover song X on the final product, whichever is greater. The service provider may also provide the copyright owner(s) a monthly and annual accounting of distributions of cover song X, along with monthly payments of the mechanical royalties calculated in the manner described above.

In an alternate embodiment, computing device 16 is omitted from system 10 of FIG. 1 to simplify the setup and operation of system 10. In this embodiment, the processed audio signal from input processor 12 is transmitted directly to master recorder 18 and copied onto MCDs 50 as is indicated by dotted line 13 of FIG. 1. As indicated above, the processed audio signal in this embodiment may be an analog signal, which may be converted to a digital form by A/D converter 30 included in master recorder 18. More specifically, master recorder 18 is configured, in this embodiment, to receive break inputs (similar to break inputs 42) indicating transitions between segments of the performance, as the processed signal from input processor 12 is being copied onto hard drive 46, thereby creating edited segment files 44. Simultaneously, edited segment files 44 are copied to one or more MCDs 50 in the manner described above. MCDs 50 are then duplicated as described above. It should be understood, however, that it is within the scope of the present invention to copy the processed audio signal from input processor 12 (or the original audio signal(s) from front of house console 22) directly onto an MCD 50 (or multiple MCDs 50) without creating edited segment files 44. It should also be understood that it is within the ability of a skilled artisan to route the processed audio signal (or original audio signal) directly to duplicators 20 for real time duplication onto FCDs 56.

In yet another embodiment of the invention, depicted in FIG. 7, system 200 is shown as a substantially wireless, networked system wherein attendees download final products as the event occurs. More specifically, like the previously described systems, system 200 includes artist equipment 24, front of house console 22, and ambient microphones 26. System 200 also includes an input processor 202 that receives the original audio signal from front of house console 22. Input processor 202 may include a mixer 204, an A/D converter 206, and an equalizer 208 to carry out functions described above with reference to system 10. Input processor 202 may further include a transmitter 210 configured to transmit the processed audio signal via a wired or wireless connection to a network 212. In one variation of this embodiment, network 212 is the internet to provide ubiquitous access to a server 214 by personal computing devices 216 as is further described below. In such an embodiment, transmitter 210 is a conventional modem or other device for providing a connection to the internet. It should be understood, however, that network 212 may illustratively include multiple public or private LANs and/or WANs (not shown) that are operably coupled to one another via routers, switches, hubs, gateways, proxies, and/or firewalls (not shown).

Server 214 may be a computing device similar to computing device 16 in that server 214 may include (in addition to a display, input device(s), microprocessor(s), etc. (none shown)) a hard drive 216 for storing a raw event file 218, segment files 220, and editing software 222. Server 214 may also be configured to receive break inputs 224 in the manner described above with respect to system 10. Server 214 may be connected to network 212 using any of a variety of conventional transceiver devices (not shown).

In operation, server 214 functions in substantially the same way as computing device 16 described above. As the event is occurring, server 214 stores the processed audio signals obtained from input processor 202 via network 212 on hard drive 216 in raw event file 218. An operator of server 214 may provide break inputs 224 between segments of the performance (or such break inputs may be provided automatically) to create segment files 220. Using editing software 222, segment files 220 may be further edited in the manner described above to alter the content of segment files 220. After any desired editing, each segment file 220 (or edited segment file) it is formatted for downloading, which may include inserting copyright protection technology as mentioned above, as a final product by personal computing devices 216 as described below.

Personal computing devices 216 may be any of a variety of conventional devices capable of wirelessly receiving and storing digital audio files. For example, personal computing devices 216 may be web-enabled hand-held devices for receiving and storing MP3 files, web-enabled personal digital assistant devices, web-enable telephones, etc. Regardless of the specific device or audio formatting standard employed, personal computing devices 216 may connect to server 214 via network 212 before or during the event and automatically download final products as such files are made available by server 214. In this manner, attendees directly receive personal copies of the performance substantially in real time without having to wait for distribution of physical copies of the performance (e.g., MCDs 50). In this way, the service provider need only setup input processor 202 (and perhaps one or more POS sites) at the venue, as is further described below. Server 214 may be located either within the venue or remote from the venue such as, for example, in a vehicle or even in a stationary location corresponding to the service provider's office.

Sales or authorized distribution of final product using this embodiment may entail collecting payments in exchange for authorization codes, account numbers and passwords, or some other information or identification procedure that the attendee may use to access final products from server 214. For example, server 214 may be used to operate a website having a conventional secured interface such as a user name and password screen. When the service provider pre-sells the final product, for example, using any of the above described techniques for pre-selling, the service provider may give the attendee a user name and password. Server 214 will be updated with data indicating that the assigned user name/password combination is authorized to receive a final product. Before the beginning of the event, the attendee may log in to the server 214 operated website using the pre-assigned user name and password. The attendee may then simply remain logged on to the website to automatically download a final product as it is created. Of course, any suitable type of encryption technology may be employed to protect the transmission of both the processed audio signal and the final product from unauthorized reception.

The foregoing description of the device is illustrative only, and is not intended to limit the scope of protection of the device to the precise terms set forth. Although the device has been described in detail with reference to certain illustrative embodiments, variations and modifications exist within the scope and spirit of the device as described and defined in the following claims.

1. A method for facilitating on-site distribution of copies of a sound recording of an artist's performance at a venue, the method including the steps of:
obtaining a listing from the artist of compositions the artist plans to perform at the venue;
obtaining a commitment from the artist to perform only compositions included on the listing;
obtaining advanced permission to make and distribute recordings of each composition;
paying, after the performance, a holder of copyrights in a composition a first amount corresponding to a number of recordings of the composition distributed at the venue.

2. The method of claim 1, further including the step of obtaining a commitment from the artist to contractually require a third party to provide resources for use in making the recording.

3. The method of claim 2, wherein the resources include one of personnel, equipment, and space for equipment.

4. The method of claim 2, wherein the third party is a promoter of the performance.

5. The method of claim 1, further including the step of negotiating with the artist to determine a payment to the artist for each recording distributed.

6. The method of claim 1, further including the step of obtaining a commitment from the artist to require representatives of the artist to assist in creating the recordings.

7. The method of claim 1, further including the step of obtaining a commitment from the artist to announce the availability of the recordings during the performance.

8. The method of claim 1, further including the step of obtaining permission from the artist to use one of trademarked and copyrighted material owned by the artist.

9. The method of claim 1, further including the step of negotiating with an operator of the venue to obtain rights to distribute the recordings at the venue.

10. The method of claim 1, further including the step of negotiating with unionized personnel associated with the venue to obtain assistance from the personnel in creating the recordings.

11. The method of claim 1, further including the step of engaging a mechanical license clearinghouse organization to obtain the listing and to obtain the advanced permission.

12. The method of claim 1, wherein the obtaining advanced permission step includes the step of identifying cover songs included in the listing and obtaining an estimate of the time duration of each composition on the listing.

13. The method of claim 12, further including the step of obtaining commitments from the artist that the artist will not alter the fundamental character of any cover song, and that the artist will not seek copyright protection of any cover song as a derivative work.

14. The method of claim 1, wherein the obtaining advanced permission step includes the step of sending a request for permission to a mechanical licensing agent.

15. The method of claim 14, further including the step of serving a notice of intent letter on one of a copyright owner and a representative who has not authorized the mechanical licensing agent to grant permission to record and distribute a composition.

16. The method of claim 1, wherein the step of obtaining advanced permission includes the step of serving a notice of intent letter.

17. The method of claim 15, wherein the letter includes a name of an entity that will make the recordings, a name of an author of a composition, and a name of the artist.

18. The method of claim 1, further including the step of determining an estimated number of attendees of the performance in advance of the performance.

19. The method of claim 18, further including the step of preparing packaging materials for the recordings in a quantity that relates to the estimated number of attendees.

20. The method of claim 19, wherein the step of preparing packaging includes the steps of determining a packaging configuration and creating artist-specific materials for use with the packaging configuration.

21. The method of claim 20, wherein the step of preparing packaging further includes the step of creating event-specific materials for use with the packaging configuration.

22. The method of claim 19, wherein the packaging materials include a bar code.

23. The method of claim 1, further including the step of selling recordings before the performance.

24. The method of claim 23, wherein the step of selling recordings includes the step of preparing order tickets to distribute to purchasers of the recordings in exchange for a payment.

25. The method of claim 23, wherein the step of selling recordings includes the step of carrying a wireless credit card device to a location of attendees.

26. The method of claim 23, wherein the step of selling recordings includes the step of receiving orders for recordings before a day of the performance.

27. The method of claim 23, wherein the step of selling recordings includes the step of offering a purchaser of a ticket to the performance an opportunity to purchase a recording with the ticket purchase.

28. The method of claim 27, wherein the step of selling recordings further includes the step of including an indicator on the ticket to indicate a purchase of a recording.

29. The method of claim 23, further including the step of determining a quantity of recordings to produce based on a quantity of recordings sold before the performance.

30. The method of claim 29, wherein the step of determining a quantity of recordings to produce includes the step of estimating a demand for recordings by purchasers who did not purchase a recording before the performance.

31. The method of claim 1, further including the steps of planning for installation of equipment and materials for carrying out the method at the venue and installing the equipment and materials.

32. The method of claim 31, wherein the planning step includes the steps of identifying a location for an input processor, identifying a location for a computing device, identifying a location for a master recorder, identifying a location for a duplicator, and identifying a location for point-of-sale materials.

33. The method of claim 32, wherein the planning step further includes the steps of identifying a first route between the master recorder location and the duplicator location, and identifying a second route between the duplicator location and the location of the point-of-sale materials.

34. The method of claim 32, wherein the input processor location is within a vehicle.

35. The method of claim 1, further including the step of making the recordings.

36. The method of claim 35, wherein each recording includes a plurality of CDs, one CD of each plurality of CDs including content representing a beginning of the performance and another CD of each plurality of CDs including content representing an ending of the performance.

37. The method of claim 36, wherein the content of the other CD is shorter in duration that the content of the one CD.

38. The method of claim 35, wherein the making step includes the steps of creating a raw event file on a hard drive, and dividing the raw event file into segment files, each segment file including a song performed during the performance.

39. The method of claim 38, wherein one of the segment files includes a plurality of songs performed during the performance.

40. The method of claim 38, wherein the making step further includes the step of copying the segment files onto a master CD.

41. The method of claim 38, wherein the making step further includes the step of simultaneously copying the segment files onto a plurality of master CDs.

42. The method of claim 38, wherein the making step further includes the step of copying the segment files from the hard drive onto a plurality of final CDs.

43. The method of claim 42, wherein the step of copying the segment files includes the step of transmitting the segment files over a network.

44. The method of claim 38, further including the step of burning titles of the songs onto the recordings.

45. The method of claim 35, wherein the creating step further includes the steps of creating a master copy of the performance and hand-carrying the master copy to a duplicator configured to create a plurality of final copies.

46. The method of claim 35, further including the steps of creating a listing of segments performed during the performance and including the listing with the recordings.

47. The method of claim 1, further including the step of distributing the recordings after a day of the performance.

48. The method of claim 47, further including the step of paying the holder of copyrights a second amount corresponding to a number of recordings of the composition distributed after the day of the performance.

49. The method of claim 47, wherein the distributing step includes the step of processing one of an on-line order for a recording, a telephone order for a recording, a mail order for a recording, and an order for a recording at a subsequent performance by the artist.

50. The method of claim 1, wherein the paying step includes the step of computing a royalty by determining the time duration of the composition.

51. The method of claim 1, further including the step of providing, during the performance, a streaming audio signal of the performance.

52. A method for distributing copies of a recording of an artist's performance at a venue, the method including the steps of:
obtaining, before the performance, a compulsory license to a composition to be performed at the venue;
recording the composition;
distributing copies of the recorded composition at the venue; and
paying, after the performance, a royalty under the compulsory license.

53. The method of claim 51, further including the step of obtaining agreement of a promoter to contractually require the venue to provide resources for use in making the copies.

54. The method of claim 51, further including the step of negotiating with an operator of the venue to obtain rights to distribute the copies at the venue.

55. The method of claim 51, wherein the obtaining a compulsory license step includes the step of identifying the composition as a cover song.

56. The method of claim 51, further including the step of obtaining a listing from the artist of compositions the artist intends to perform at the venue.

57. The method of claim 51, wherein the step of obtaining a compulsory license includes the step of serving a notice of intent letter on a holder of copyrights in the composition.

58. The method of claim 51, further including the step of receiving money for copies of the recorded composition before completing the recording step.

59. The method of claim 57, further including the step of offering a purchaser of a ticket to the performance an opportunity to purchase a copy of the recorded composition with the ticket purchase.

60. The method of claim 51, wherein the paying step includes the step of computing the royalty by determining the time duration of the composition.

61. A method for creating CDs embodying recordings of an artist's performance at a venue and distributing the CDs to attendees before the attendees leave the venue, the method including the steps of:
processing an original audio signal of the performance to create a processed audio signal of the performance;
using a master recorder to copy the processed audio signal onto a master CD at a master recorder site;
transporting the master CD from the master recorder site to a duplicator at a duplication site;
using the duplicator to copy the master CD onto a plurality of final CDs;
transporting the plurality of final CDs from the duplication site to a point-of-sale site; and
distributing the plurality of final CDs to the attendees.

62. The method of claim 60, further including the step of obtaining a listing from the artist of compositions the artist plans to perform at the venue.

63. The method of claim 61, further including the step of obtaining advanced permission from a holder of copyrights in each composition on the listing to make and distribute the final CDs.

64. The method of claim 62, further including the step of paying the copyright holders, after the performance, a first amount corresponding to a number of final CDs distributed at the venue.

65. The method of claim 60, further including the step of negotiating with an operator of the venue to obtain rights to distribute the final CDs at the venue.

66. The method of claim 62, wherein the obtaining advanced permission step includes the step of identifying cover songs included in the listing.

67. The method of claim 62, wherein the obtaining advanced permission step includes the step of serving a notice of intent letter on a holder of copyrights in a composition.

68. The method of claim 62, wherein the obtaining advanced permission step includes the step of sending a request to a mechanical licensing agent for permission to make and distribute the final CDs sufficiently in advance of the performance that the mechanical licensing agent may respond to the request before the performance.

69. The method of claim 67, further including the step of serving a notice of intent letter on a holder of copyrights in a composition who has not authorized the mechanical licensing agent to grant permission on behalf of the copyright holder.

70. The method of claim 60, further including the steps of creating a raw event file on a hard drive, and dividing the raw event file into segment files, each segment file representing a song performed during the performance.

71. The method of claim 60, wherein the step of using a master recorder includes the step of simultaneously copying a plurality of segment files onto a plurality of master CDs.

72. An apparatus for recording a performance at a venue and distributing copies of the recording at the venue to attendees, including:
an input processor configured for coupling to a front of house console to receive an original audio signal representing an audio component of the performance, the input processor outputting a processed audio signal; and
a computing device coupled to the input processor having a hard drive, the computing device being configured to store the processed audio signal in a raw event file on the hard drive as the performance is occurring, the computing device being further configured to create segment files on the hard drive as the raw event file is being created, each segment file including a song performed during the performance.

73. The apparatus of claim 71, further including a backup recorder coupled to the input processor, the backup recorder including a hard drive for storing a copy of the processed audio signal.

74. The apparatus of claim 71, wherein the input processor includes a mixer configured to mix a plurality of channels included in the original audio signal.

75. The apparatus of claim 71, wherein the input processor includes an A/D converter configured to convert the original audio signal from an analog form to a digital form.

76. The apparatus of claim 71, wherein the input processor includes an equalizer configured to adjust levels of components of the original audio signal.

77. The apparatus of claim 71, wherein the computing device is configured to receive a break input indicating a transition between one song of the performance and another song of the performance, the computing device creating a segment file in response to receipt of the break input.

78. The apparatus of claim 76, wherein the break input is provided by an operator of the computing device.

79. The apparatus of claim 76, wherein the break input is provided by audio sensing equipment configured to detect a transition between the one song and the other song.

80. The apparatus of claim 71, wherein the computing device includes editing software to enable editing of content of segment files.

81. The apparatus of claim 71, further including a master recorder coupled to the computing device, the master recorder including a hard drive for storing segment files created by the computing device.

82. The apparatus of claim 80, wherein the master recorder further includes a media receptacle for receiving a master media, the master recorder being configured to copy the segment files stored on the master recorder hard drive onto the master media.

83. The apparatus of claim 81, wherein the master media is a compact disc.

84. The apparatus of claim 80, wherein the master recorder further includes a plurality of media receptacles for receiving a plurality of master media, the master recorder being configured to simultaneously copy the segment files stored on the master recorder hard drive onto the plurality of master media.

85. The apparatus of claim 81, further including a duplicator configured to copy the segment files stored on the master recorder hard drive onto a plurality of final media.

86. The apparatus of claim 83, further including a plurality of duplicators each having a master media receptacle for receiving one of the plurality of master media, and a plurality of additional media receptacles for receiving a plurality of final media, each duplicator being configured to simultaneously copy the one master media onto the plurality of final media.

87. The apparatus of claim 83, further including a plurality of duplicators each having a plurality of media receptacles for receiving a plurality of final media, the plurality of duplicators being configured to simultaneously copy one of the plurality of master media onto the plurality of final media.

88. The apparatus of claim 84, wherein the duplicator is mounted within a vehicle.

89. The apparatus of claim 71, wherein the computing device is coupled to the input processor via a network.

90. The apparatus of claim 88, wherein the network is the internet.

91. The apparatus of claim 88, wherein the network is wireless.

92. The apparatus of claim 88, wherein the computing device is configured to format each segment file for downloading via the network.

93. The apparatus of claim 88, wherein the computing device includes a server that operates a website on the network.

94. The apparatus of claim 91, wherein the computing device is configured to format each segment file in MP3 format for downloading by a personal computing device operated by an attendee at the venue.

95. The apparatus of claim 88, wherein the computing device is configured to process payments in exchange for information with which an attendee may download a copy of the recording while attending the performance.

96. The apparatus of claim 94, wherein the information includes an account number and password.

97. The apparatus of claim 91, wherein the formatted segment files are encrypted to inhibit unauthorized downloading of the formatted segment files.

98. An apparatus for creating recorded copies of a performance at a venue for distribution at the venue when the performance is over, including:
an input processor configured to receive an original audio signal from a front of house console, the input processor outputting a processed audio signal;
a master recorder directly coupled to the input processor, the master recorder being configured to copy the processed audio signal onto a master CD; and
a duplicator configured to simultaneously copy the master CD onto a plurality of final CDs for distribution.

99. The apparatus of claim 97, wherein the master recorder is configured to receive break inputs that define transitions between songs included in the performance.

100. The apparatus of claim 97, wherein the master recorder includes a storage device for storing segments of the processed audio signal in segment files which are copied onto the master CD.
